(19) United States
(12) Patent Application Publication
(10) Pub. No.: US 2022/0369604 A1
(43) Pub. Date: Nov. 24, 2022

(54) DEPTH WIRE-CONTROLLED AQUACULTURE DEVICE

(71) Applicant: NATIONAL TAIWAN OCEAN UNIVERSITY, Keelung City (TW)

(72) Inventors: CHUNG-CHENG CHANG, KEELUNG CITY (TW); CHEN-CHOU LIN, TAIPEI CITY (TW)

(21) Appl. No.: 17/324,202

(22) Filed: May 19, 2021

(51) Int. Cl. A01K 61/60

(52) U.S. Cl. CPC A01K 61/60

(57) ABSTRACT

A depth wire-controlled aquaculture device, having a net cage, float balls, a depth sensor and at least one wire control module, is illustrated. The net cage has a frame and a net body. The float balls are connected to the net cage. The depth sensor is installed on the net cage and detects an underwater depth of the net cage to generate a depth signal. The wire control module comprises a controller, a reel, a driver and a connection wire. The connection wire is connected to the net cage and wound around the reel, the controller is signally connected the depth sensor and the driver, the depth signal is transmitted to the controller, the controller controls the driver according to the depth signal, and the driver drives the reel to rotate to draw or release the connection wire, so as to change the underwater depth of the net cage.

### BACKGROUND

### 1. Technical Field

The present disclosure relates to the technical field of an aquaculture system, and particularly relates to a depth wire-controlled aquaculture device that controls the underwater depth of the net cage by drawing or releasing the connection wire of the net cage.

### 2. Related Art

With the rapid expansion of the global population, the rate of consumption of edible aquatic products has accelerated with the increase in the total population. In addition, in recent years, due to the overfishing, the pollution of the marine environment and the impact of global climate change, natural fishery resources are increasingly scarce, and in order to make up for the huge demand for edible aquatic products, global aquaculture fisheries accordingly grows rapidly.

At present, the conventional sinking/floating net cage is still technically immature in use. The conventional sinking/floating net cage at least includes a net bag, a floating frame unit and a hollow tube. The floating frame unit can float on a sea surface. The net bag is arranged around the floating frame unit and forms a breeding space. The hollow tube is arranged around the floating frame unit. Because the conventional sinking/floating net cage cannot automatically float up or sink down and is mostly placed on the sea for a long time, the conventional sinking/floating net cage is often difficult to withstand the impact of the waves for a long time when facing typhoons or periodic monsoon waves, causing the sinking/floating net cage to move freely from the original breeding site. Thus, it causes heavy losses to fish farmers, and even more because the net bag ruptured, causing a large number of fish to escape, the yielding rate of fish farming is affected. In addition, every marine organism has a suitable ocean depth position for life, and the conventional sinking/floating net cage cannot adjust the ocean depth position of the sinking/floating net cage at any time, which makes it difficult to breed marine organisms of different ocean depths. Therefore, how to use innovative hardware design to effectively improve the mobility of the conventional sinking/floating net cage to cope with various situations that may cause fish farmers to lose fish and to expand the species of marine organisms in different ocean depths, is an issue that related industry developers and related researchers need to continue to work hard to overcome and solve.

### SUMMARY

In view of this, the purpose of the present disclosure is to provide a depth wire-controlled aquaculture device, which can instantly adjust the underwater depth of the net cage according to the marine environment and aquaculture conditions, and thus the depth environment that various aquatic products can adapt to is adjusted, so as to avoid the impact of various sea conditions on breeding.

According to one embodiment of the present disclosure, a depth wire-controlled aquaculture device is illustrated, and the aquaculture device comprises a net cage, float balls, a depth sensor and at least one wire control module. The net cage comprises a frame and a net body installed on the frame. The float balls are connected to the net cage and generate buoyancy to support the weight of the net cage. The depth sensor is installed on the net cage and detects an underwater depth of the net cage to generate a depth signal. The wire control module comprises controller, a reel, a driver and a connection wire, wherein the connection wire is connected to the net cage and wound on the reel, the controller is signally connected the depth sensor and the driver, the depth signal is transmitted to the controller, the controller controls the driver according to the depth signal, and the driver drives the reel to rotate to draw or release the connection wire, so as to change the underwater depth of the net cage.

According to the above features, the wire control module further comprises a float tube, and the controller, the reel and the driver are installed on the float tube.

According to the above features, the depth wire-controlled aquaculture device further comprises multiple wire control modules, the wire control modules are disposed corresponding to the float tubes, and the float tubes and the wire control modules are arranged in pairs.

According to the above features, the controller comprises a first processing module, a programmable controller module electrically connected to the first processing module, and a first wireless communication module electrically connected to the first processing module, the depth signal is transmitted to the first processing module, and compared with a setting value set in the programmable controller module, and the depth signal is transmitted via the first wireless communication module.

According to the above features, the depth wire-controlled aquaculture device further comprises a global positioning unit, the global positioning unit detects a satellite signal and generates a geographic coordinate position signal, and the geographic coordinate position signal is transmitted via the first wireless communication module.

According to the above features, the depth wire-controlled aquaculture device further comprises an accelerometer, the accelerometer is electrically connected to the first processing module of the controller, the accelerometer detects the movement state of the net cage to generate an acceleration signal, and the acceleration signal is transmitted via the first wireless communication module.

According to the above features, the depth wire-controlled aquaculture device further comprises a marine environment monitoring system the marine environment monitoring system comprises a second processing module, a data analyzing unit, a parameter setting unit and a second wireless communication module, the depth signal, the geographic coordinate position signal and the acceleration signal are transmitted to the second processing module via the second wireless communication module, the second processing module transmits the depth signal and the geographic coordinate position signal to the data analyzing unit, the parameter setting unit generates a control signal according to an analysis result, the control signal is transmitted to the wire control modules via the second wireless communication module, and the wire control module controls the connection wire to be drawn or released according to the control signal.

According to the above features, the marine environment monitoring system further comprises at least one of a wave sensor, a water temperature sensor, a water quality sensor and a wind speed sensor.

According to the above features, the depth wire-controlled aquaculture device further comprises an onshore processing center, the marine environment monitoring system (50) is installed in the onshore processing center, the onshore processing center is linked to the wire control modules via a network, and the depth signal, the geographic coordinate position signal and the acceleration signal are transmitted to the onshore processing center via the network.

According to the above features, the depth wire-controlled aquaculture device further comprises a cloud data center, the cloud data center is linked to the onshore processing center, and the depth signal, the geographic coordinate position signal and the acceleration signal are transmitted from the onshore processing center to the cloud data center for computing.

According to the above features, the depth wire-controlled aquaculture device further comprises an offshore station, the marine environment monitoring system is installed in the offshore station, the wire control modules are linked to the offshore station via a network, the depth signal, the geographic coordinate position signal and the acceleration signal is transmitted to the offshore station via the network, and the control signal is transmitted to the wire control module via the network.

According to the above features, the depth wire-controlled aquaculture device further comprises a work boat, the marine environment monitoring system is installed in the work boat, and the work boat receives the depth signal, the geographic coordinate position signal and the acceleration signal via a network, and sends the control signal to the wire control module via the network.

The depth wire-controlled aquaculture device of the present disclosure uses the depth sensor to detect the underwater depth of the net cage to generate the depth signal, and according to the setting of the marine environment and aquaculture conditions, the controller controls the driver to drive the reel to rotate, thereby drawing or releasing the connection wire to change the underwater depth of the net cage. The onshore processing center, the offshore station or the work boat collects marine environmental data and generates control signals, which are sent to the wire control module to control the rotation of the reel to adjust the underwater depth of the net cage, thereby assisting the fish farmers to flexibly control the net cage with reel when facing sudden marine natural disasters, so as to greatly reduce the loss of fish farmers.

### BRIEF DESCRIPTIONS OF DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a three-dimensional view of a depth wire-controlled aquaculture device according to one embodiment of the present disclosure.

FIG. 2 is a three-dimensional view of a depth wire-controlled aquaculture device according to another one embodiment of the present disclosure.

FIG. 3 is a three-dimensional view of a depth wire-controlled aquaculture device according to another one embodiment of the present disclosure.

FIG. 4 is a function block diagram of a depth wire-controlled aquaculture device according to one embodiment of the present disclosure.

FIG. 5 is a schematic diagram showing the sinking down of the depth wire-controlled aquaculture device.

FIG. 6 is a schematic diagram showing the floating up of the depth wire-controlled aquaculture device.

FIG. 7 is a schematic diagram showing that the marine environment monitoring system of the depth wire-controlled aquaculture device monitors each net cage.

FIG. 8 is a three-dimensional view of a depth wire-controlled aquaculture device according to another one embodiment of the present disclosure.

FIG. 9 is a three-dimensional view of a depth wire-controlled aquaculture device according to another one embodiment of the present disclosure.

FIG. 10 is a schematic diagram showing a whole arrangement of the depth wire-controlled aquaculture device.

### DESCRIPTIONS OF EXEMPLARY EMBODIMENTS

To understand the technical features, content and advantages of the present disclosure and its efficacy, the present disclosure will be described in detail with reference to the accompanying drawings. The drawings are for illustrative and auxiliary purposes only and may not necessarily be the true scale and precise configuration of the present disclosure. Therefore, the scope of the present disclosure should not be limited to the scale and configuration of the attached drawings.

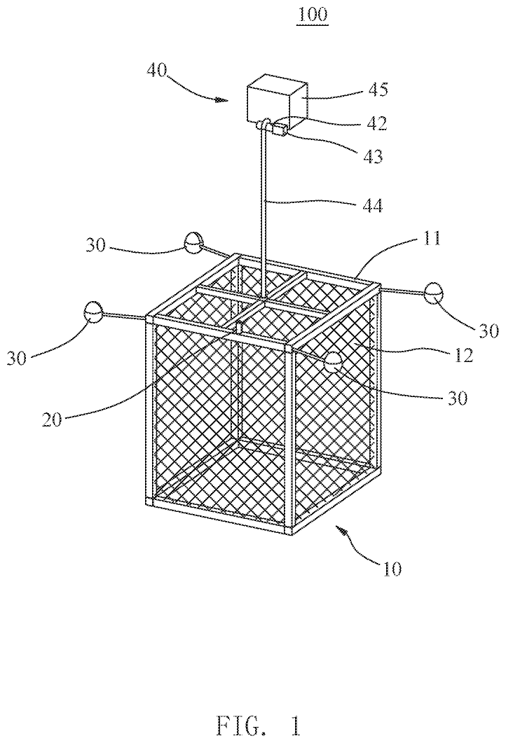

Please refer to FIG. 1, which shows an embodiment of the depth wire-controlled aquaculture device of the present disclosure. The depth wire-controlled aquaculture device 100 of this embodiment includes a net cage 10, a depth sensor 20, a plurality of float balls 30 and at least one wire control module 40.

The net cage 10 includes a frame 11 and a net body 12, and the net body 12 is set on the frame 11. The net body 12 forms a breeding space around the frame 11. In implementation, the net body 12 can prevent the fish in the breeding space from escaping. The frame 11 is further surrounded by a plurality of floating tubes (not shown in the drawings). The floating tubes form a ring structure with each other. The ring structure is disposed on the internally formed breeding space, which is beneficial for fish farmers to stand and work on the frame 11. There can be an armrest at the upper end of frame 11 (not shown in the drawings). When the net cage 10 is shaken by waves or ocean currents, the fish farmer can use the armrest to keep standing on frame 11 and work to avoid the fish farmer to fall down due to instability.

The depth sensor 20 is set in the net cage 10 to detect the underwater depth of the net cage 10 and generate a depth signal. The float balls 30 are connected to the frame 11 of the net cage 10, and the buoyancy generated by the float balls 30 supports the weight of the net cage 10. The float balls 30 of this embodiment support a part of the weight of the net cage 10. The depth sensor 20 can be a piezoelectric IC or a strain gauge, and the value of the underwater depth (i.e. the depth under the water surface) is obtained by detecting the water pressure.

The wire control module 40 includes a controller 41, a reel 42, a driver 43, and a connection wire 44. The connection wire 44 is connected to the net cage 10 and wound around the reel 42. The controller 41 is electrically connected to the depth sensor 20 and the driver 43, the depth signal is transmitted to the controller 41, and the controller 41 compares the depth signal with a setting value, and controls the driver 43 according to the comparison result, or the controller 41 controls the driver 43 according to the externally transmitted control signal, so that the driver 43 drives the reel 42 to rotate to draw or release the connection wire 44 to change the underwater depth of the net cage 10. The driver 43 can be, for example, a servo motor, the reel 42 can be, for example, a hub-shaped member, and the connection wire 44 can be a cable or an iron chain. The force applied on the net cage 10 includes the weight of the net cage 10, the buoyancy of the water acting on the float balls 30, and the pulling force applied on the net cage 10 by the connection wire 44. Therefore, when wanting the net cage 10 to stay in any position underwater, the force applied to the net cage 10 should achieve the force balance state. Therefore, the weight of the net cage 10 is equal to the sum of the buoyancy of the float balls 30 and the pulling force of the connection wire 44, so that the reel 42 can adjust the position of the net cage 10 underwater when the connection wire 44 is drawn or released. On the other hand, because tension must be generated on the connection wire 44 so that the position of the net cage 10 underwater can be adjusted by drawing or releasing connection wire 44, the buoyancy generated by all float balls 30 must be set to be less than the weight of the net cage 10.

As shown in FIG. 1, the wire control module 40 further includes a float tube 45, and the controller 41, the reel 42 and the driver 43 are arranged on the float tube 45. The buoyancy generated by the water on the float tube 45 and the tension of the connection wire 44 achieve the force balance state, so that the wire control module 40 keeps floating on the water surface by the float tube 45, that is, the total sum of the buoyancy generated by the water on the float tube 45 and the buoyancy generated by the water on the float balls 30 should be equal to the weight of the net cage 10, so that the net cage 10 can stay at any position underwater. In another embodiment, the wire control module 40 can also be installed on the land, for example, fixed in a structure on the land.

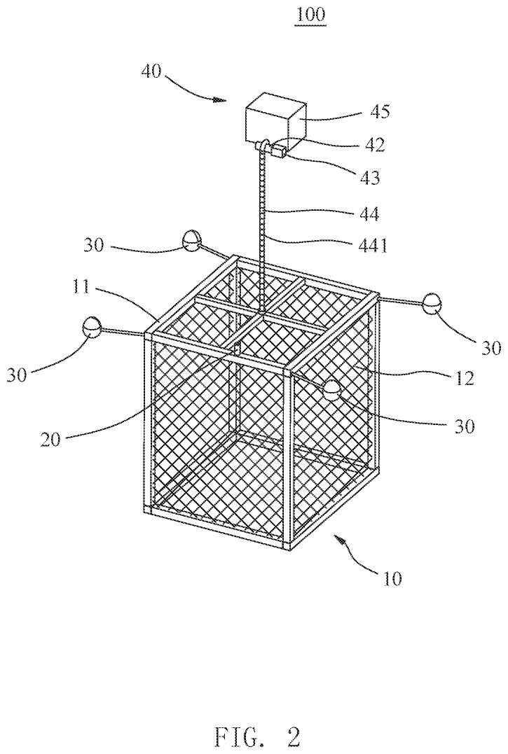

Please refer to FIG. 2, which shows another one embodiment of the depth wire-controlled aquaculture device. This embodiment has the same structure as that of the embodiment shown in FIG. 1, so the same elements are given the same symbols and their descriptions are omitted. The connection wire 44 of this embodiment is provided with a plurality of depth indication scales 441. As the connection wire 44 is drawn or released, and one of the depth indication scales 441 is aligned with an indicator, the current underwater depth of the net cage 10 is displayed, allowing the fish farmer onshore or offshore can visually understand the depth of the current net cage 10.

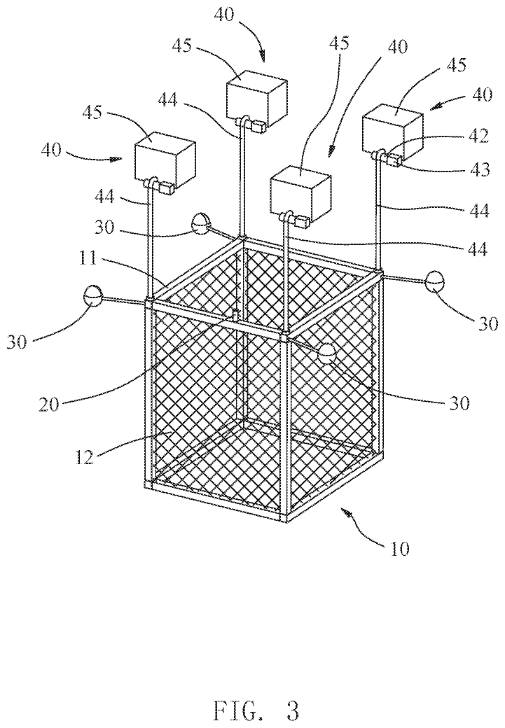

Please refer to FIG. 3, which shows another embodiment of the depth wire-controlled aquaculture device. This embodiment has the same structure as that of the embodiment shown in FIG. 1, so the same elements are given the same symbols and their descriptions are omitted. The depth wire-controlled aquaculture device 100 of this embodiment includes a plurality of wire control modules 40, and the wire control module 40 are disposed corresponding to the float tube 45, and the float tubes 45 and the wire control modules 40 are arranged in pairs. Since this embodiment has the multiple wire control modules 40, it can be used for a net cage 10 with a larger volume or a heavier weight, and by symmetrically setting the multiple wire control modules 40 relative to the net cage 10, the net cage 10 can sink down or float up in a stable and balanced manner.

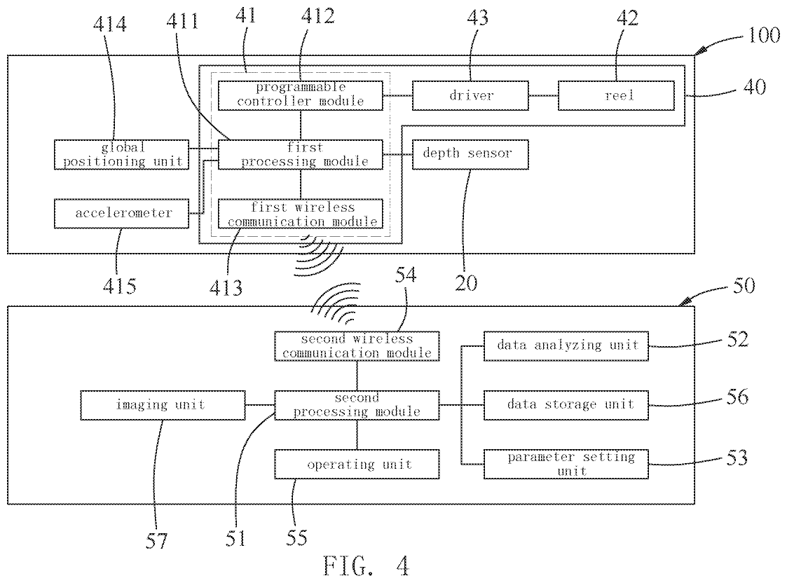

Please refer to FIG. 4, the controller 41 includes a first processing module 411, a programmable controller module 412 electrically connected to the first processing module 411, and a first wireless communication module 413 electrically connected to the first processing module 411. The depth signal is transmitted to the first processing module 411, and compared with the setting value set in the programmable controller module 412, and the depth signal is transmitted via the first wireless communication module 413. The depth signal is transmitted to the marine environment monitoring system 50 described later via the first wireless communication module 413. The programmable controller module 412 can set programs and parameter values corresponding to various conditions. The first processing module 411 loads and executes the program codes and parameter values in the programmable controller module 412 corresponding to various conditions. The depth wire-controlled aquaculture device 100 of this embodiment further includes a global positioning unit 414 that detects a satellite signal and generates a geographic coordinate position signal. The geographic coordinate position signal is transmitted to the marine environment monitoring system 50 described later via the first wireless communication module 413. The depth wire-controlled aquaculture device 100 of this embodiment further includes an accelerometer 415, which is electrically connected to the first processing module 411. The accelerometer 415 generates an acceleration signal according to the movement state of the net cage 10, and the acceleration signal is transmitted to the marine environment monitoring system 50 described later via the first processing module 411 and the first wireless communication module 413, so that based on the acceleration signal, it can help the fish farmer to judge the movement state of the net cage 10.

In another embodiment, it further includes a camera device, the camera device, the water depth sensor, the programmable controller module 412, the first processing module 411 and the first wireless communication module 413 are electrically connected to each other. The camera device captures a fish group image, and the fish group image is converted into an image signal. The image signal is sent to the marine environment monitoring system 50 described later via the first processing module 411 and the first wireless communication module 413 for remote observation of the fish group activity status.

As shown in FIG. 4, the marine environment monitoring system 50 includes a second processing module 51, a data analyzing unit 52, a parameter setting unit 53 and a second wireless communication module 54. The depth signal, the geographic coordinate position signal, the acceleration signal and the image signals are sent to the marine environment monitoring system 50 and further sent to the second processing module 51 via the second wireless communication module 54. The second processing module 51 sends the depth signal, the geographic coordinate position signal, the acceleration signal and the image signal to the data analyzing unit 52. The analysis result can be used to generate a control signal by the parameter setting unit 53, and the control signal is transmitted to the wire control module 40 via the second wireless communication module 54. The control signal is received by the first wireless communication module 413 to control the reel 42.

The marine environment monitoring system 50 also includes an operating unit 55, a data storage unit 56 and an imaging unit 57. The marine environment monitoring system 50 collects various data generated in the aquaculture area, such as the depth signal, the geographic coordinate position signal, the acceleration signal and the image signal. These data are stored in the data storage unit 56 by the control of the second processing module 51, or browsed and analyzed by the fish farmer via the imaging unit 57, and the fish farmer can operate the operating unit 55 and generate an operating command. The first wireless communication module 413 transmits the operating command to the processing module 411 via the second processing module 51 and the second wireless communication module 54. The processing module 411 and the programmable controller module 412 controls the driver 43 to rotate the reel 42 to draw or release the connection wire 44 according to the operating command to make the net cage 10 float up or sink down. The marine environment monitoring system 50 can receive the acceleration signal generated by the accelerometer 415 according to the movement state of the net cage 10 via the second wireless communication module 54, so that the fish farmer can monitor the acceleration signal of the accelerometer 415 via the marine environment monitoring system 50 and operate the operating unit 55 to control the movement state of the net cage 10, and then adjust the tilted angle of the net cage 10 to balance the tilted angle. The fish farmer can understand the current operating status of the net cage 10 via the depth signal and acceleration signal; or the fish farmer can use the operating unit 55 to control the net cage 10 to flow up, sink down or keep the current status; or the fish farmer can set the parameter setting unit 53 to monitor the operating status of the net cage 10 or to automatically adjust the operation of the net cage 10.

In another embodiment, the marine environment monitoring system 50 further includes at least one of a wave sensor, a water temperature sensor, a water quality sensor and a wind speed sensor. The sensors monitor the waves, water temperature, water quality, and wind speed in the breeding area, and generate monitoring data of each sensor, and the collected monitoring data of each sensor are stored in the data storage by the control of the second processing module 51 unit 56, or the fish farmer can operate the operating unit 55 to browse or analyze the monitoring data of waves, water temperature, water quality, and wind speed in the breeding area.

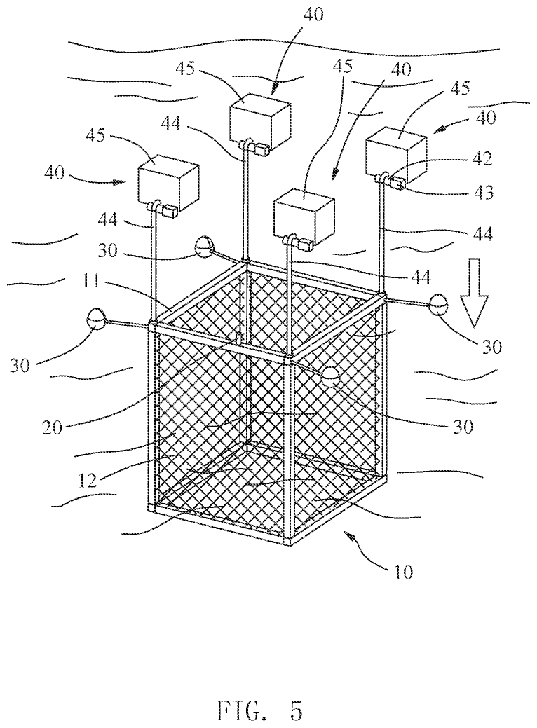

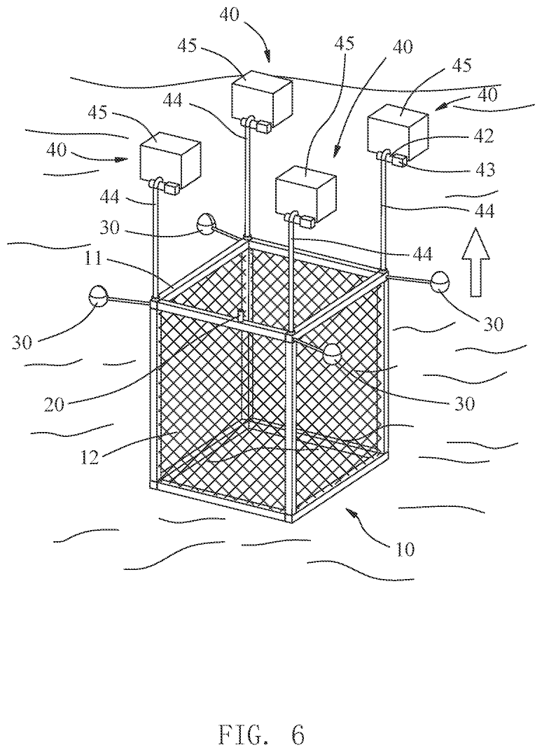

Please refer to FIG. 5, and when the net cage 10 does not reach the predetermined underwater depth or the controller 41 receives a control signal, the controller 41 controls the driver 43 to rotate the reel 42 to release the connection wire 44, so that the net cage 10 sinks down to the predetermined underwater depth. Please refer to FIG. 6, and when the net cage 10 is about to float up, the controller 41 controls the driver 43 to rotate the reel 42 to draw the connection wire 44 to make the net cage 10 float up to the predetermined underwater depth or water surface.

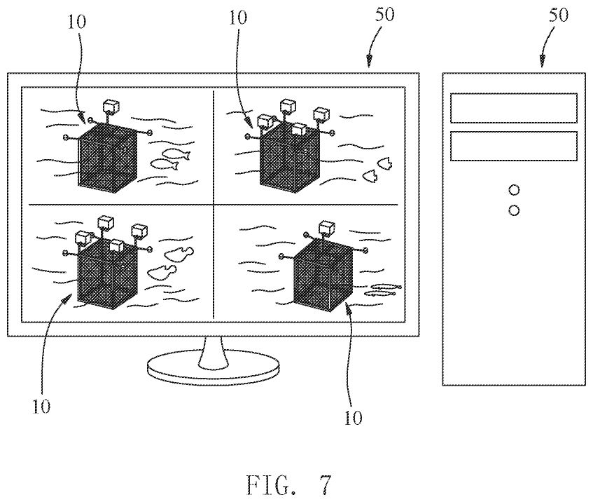

Please refer to FIG. 7, and by using the imaging unit 57, the fish farmer can operate the marine environment monitoring system 50 to browse and analyze the status of each net cage 10.

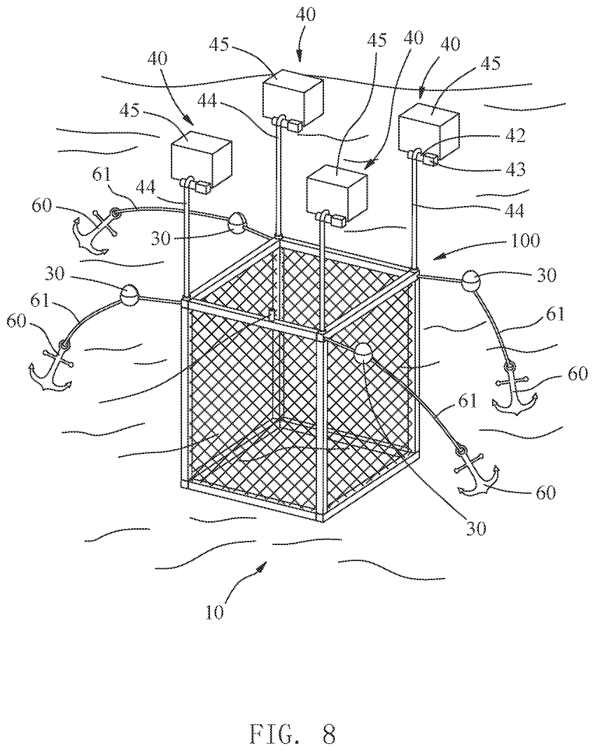

Please refer to FIG. 8, which shows yet another embodiment of the depth wire-controlled aquaculture device of the present disclosure. This embodiment has the same structure as that of the embodiment shown in FIG. 3, so the same elements are given the same symbols and their descriptions are omitted. The depth wire-controlled aquaculture device 100 of this embodiment further includes a plurality of anchors 60, and the anchors 60 are connected to the float balls 30 and are sunk underwater. The anchors 60 can be exemplified but not limited to cement blocks, iron anchors, and cage bags. The main function of the anchor 60 is to fix the net cage 10 with reel 42 in the sea area planned by the fish farmer to prevent the net cage 10 with reel 42 from being affected by waves and currents to drift out of the planned sea area. The anchor 60 is connected to the float ball 30 by the cable 61. The cable 61 is mainly used to slow down waves or currents which form the pulling effect on net cage 10. The float ball 30 can oscillate up and down by buoyancy to delay waves and currents which form the pulling effect on net cage 10 with the reel 42.

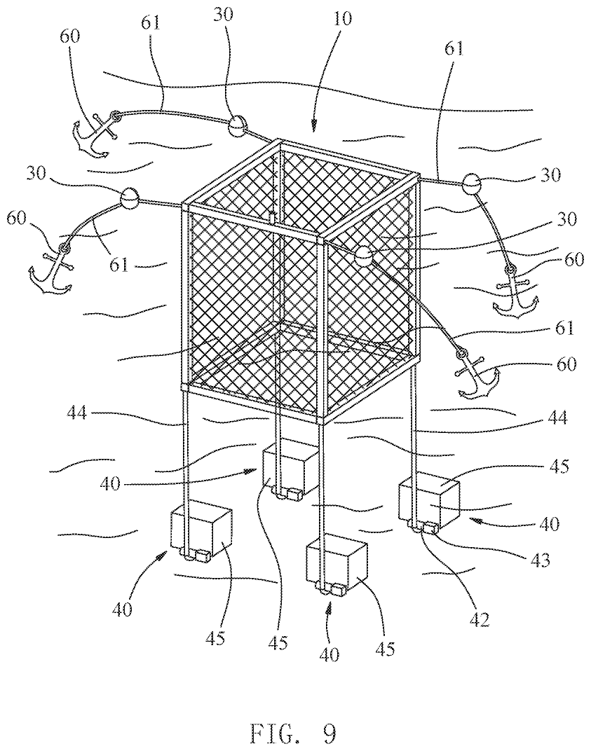

Please refer to FIG. 9, which shows yet another embodiment of the depth wire-controlled aquaculture device of the present disclosure. This embodiment has the same structure as that of the embodiment shown in FIG. 8, so the same elements are given the same symbols and their descriptions are omitted. The wire control module 40 of this embodiment is set on the seabed, so the buoyancy generated by the water on the float ball 30 is greater than the weight of the net cage 10. The connection wire 44 of the wire control module 40 generates a downward pulling force on the net cage 10, so the buoyancy generated by water on the float ball 30 is the sum of the weight of the net cage 10 and a downward pulling force generated by the water on the float ball 30. Thus, the wire control module 40 can control the underwater depth of the net cage 10 by drawing or releasing the connection wire 44.

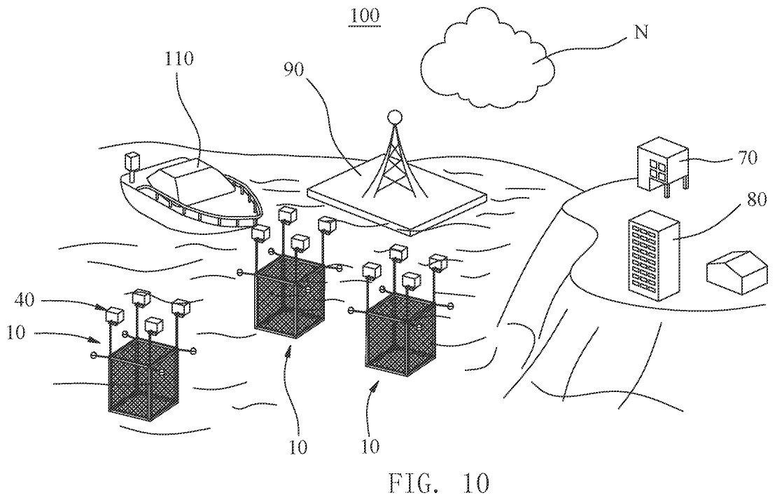

Please refer to FIG. 10, and the depth wire-controlled aquaculture device 100 of the present disclosure further includes an onshore processing center 70, a cloud data center 80, an offshore station 90, and a work boat 110. Each wire control module 40 is connected to the onshore processing center 70, the offshore station 90 and the work boat 110 via a network N. The cloud data center 80 is connected to the onshore processing center 70. The aforementioned marine environment monitoring system 50 can be installed in the onshore processing center 70, the offshore station 90, and the work boat 110. The data generated by the wire control module 40 is transmitted to the marine environment monitoring system 50 via the network N. The marine environment monitoring system 50 can analyze the data transmitted by the wire control module 40 and the wave, water temperature, water quality, and wind speed detected by the marine environment monitoring system 50 to generate the control signals. Or, the data can be transmitted to cloud data center 80 for storage and big data analysis, wherein the big data analysis considers the marine environment, aquatic product species and net cage structure to obtain the best control plan for controlling the movement of the net cage 10.

The depth wire-controlled aquaculture device of the present disclosure uses the depth sensor to detect underwater depth of the net cage to generate the depth signal, and according to the setting of the marine environment and aquaculture conditions, the controller controls the driver to drive the reel to rotate, thereby drawing or releasing the connection wire to change the underwater depth of the net cage. The onshore processing center, the offshore station or the work boat collects marine environmental data and generates the control signal, which is sent to the wire control module to control the reel to rotate and adjust the underwater depth of the net cage, thereby assisting the fish farmer to flexibly control the net cage with reel when facing sudden marine natural disasters, so as to greatly reduce the loss of fish farmer.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A depth wire-controlled aquaculture device, comprising:
a net cage, comprising a frame and a net body installed on the frame;
multiple float balls, connected to the net cage, generating buoyancy to support the weight of the net cage;
a depth sensor, installed on the net cage, detecting an underwater depth of the net cage to generate a depth signal; and
at least one wire control module, comprising a controller, a reel, a driver and a connection wire, wherein the connection wire is connected to the net cage and wound around the reel, the controller is signally connected the depth sensor and the driver, the depth signal is transmitted to the controller, the controller controls the driver according to the depth signal, and the driver drives the reel to rotate to draw or release the connection wire, so as to change the underwater depth of the net cage.

2. The depth wire-controlled aquaculture device of claim 1, wherein the wire control module further comprises a float tube, and the controller, the reel and the driver are installed on the float tube.

3. The depth wire-controlled aquaculture device of claim 2, further comprising multiple wire control modules, the wire control modules are disposed corresponding to the float tubes, and the float tubes and the wire control modules are arranged in pairs.

4. The depth wire-controlled aquaculture device of claim 1, further comprising multiple anchors, the anchors are connected to the float balls and are sunk underwater.

5. The depth wire-controlled aquaculture device of claim 1, wherein the connection wire has multiple depth indication scales.

6. The depth wire-controlled aquaculture device of claim 1, wherein the controller comprises a first processing module, a programmable controller module electrically connected to the first processing module, and a first wireless communication module electrically connected to the first processing module, the depth signal is transmitted to the first processing module, and compared with a setting value set in the programmable controller module, and the depth signal is transmitted via the first wireless communication module.

7. The depth wire-controlled aquaculture device of claim 6, further comprising a global positioning unit, the global positioning unit detects a satellite signal and generates a geographic coordinate position signal, and the geographic coordinate position signal is transmitted via the first wireless communication module.

8. The depth wire-controlled aquaculture device of claim 7, further comprising an accelerometer, the accelerometer is electrically connected to the first processing module of the controller, the accelerometer detects the movement state of the net cage to generate an acceleration signal, and the acceleration signal is transmitted via the first wireless communication module.

9. The depth wire-controlled aquaculture device of claim 8, further comprising a marine environment monitoring system, the marine environment monitoring system comprises a second processing module, a data analyzing unit, a parameter setting unit and a second wireless communication module, the depth signal, the geographic coordinate position signal and the acceleration signal are transmitted to the second processing module via the second wireless communication module, the second processing module transmits the depth signal and the geographic coordinate position signal to the data analyzing unit, the parameter setting unit generates a control signal according to an analysis result, the control signal is transmitted to the wire control modules via the second wireless communication module, and the wire control module controls the connection wire to be drawn or released according to the control signal.

10. The depth wire-controlled aquaculture device of claim 9, wherein the marine environment monitoring system further comprises at least one of a wave sensor, a water temperature sensor, a water quality sensor and a wind speed sensor.

11. The depth wire-controlled aquaculture device of claim 9, further comprising an onshore processing center, the marine environment monitoring system is installed in the onshore processing center, the onshore processing center is linked to the wire control modules via a network, and the depth signal, the geographic coordinate position signal and the acceleration signal are transmitted to the onshore processing center via the network.

12. The depth wire-controlled aquaculture device of claim 11, further comprising a cloud data center, the cloud data center is linked to the onshore processing center, and the depth signal, the geographic coordinate position signal and the acceleration signal are transmitted from the onshore processing center to the cloud data center for computing.

13. The depth wire-controlled aquaculture device of claim 9, further comprises an offshore station, the marine environment monitoring system is installed in the offshore station, the wire control modules are linked to the offshore station via a network, the depth signal, the geographic coordinate position signal and the acceleration signal is transmitted to the offshore station via the network, and the control signal is transmitted to the wire control module via the network.

14. The depth wire-controlled aquaculture device of claim 9, further comprising a work boat, the marine environment monitoring system is installed in the work boat, and the work boat receives the depth signal, the geographic coordinate position signal and the acceleration signal via a network, and sends the control signal to the wire control module via the network.

15. The depth wire-controlled aquaculture device of claim 9, wherein the marine environment monitoring system further comprises an operating unit and a data storage unit, the depth signal, the geographic coordinate position signal and the acceleration signal are stored in the data storage unit via the control of the second processing module, and the operating unit generates an operating command.
